(19) United States
(12) Patent Application Publication
(10) Pub. No.: US 2012/0075325 A1
(43) Pub. Date: Mar. 29, 2012

(54) SYSTEMS AND METHODS FOR DISPLAYING MOLECULAR PROBES AND CHROMOSOMES

(75) Inventors: Nathan Kurtyka, Chicago, IL (US); Matt Young, Chicago, IL (US); David Stinnette, Chicago, IL (US); Christin Lyday, Chicago, IL (US); Kathryn Becker, Montgomery, IL (US)

(73) Assignee: ABBOTT LABORATORIES, Abbott Park, IL (US)

(21) Appl. No.: 13/228,526

(22) Filed: Sep. 9, 2011

Related U.S. Application Data
(60) Provisional application No. 61/381,292, filed on Sep. 9, 2010.

(51) Int. Cl. G09G 5/02; G06T 11/00

(52) U.S. Cl. 345/589; 345/467

(57) ABSTRACT

The present invention relates to systems and methods for displaying molecular probes and chromosomes, and chromosome information with which the probes are associated.

### CROSS-REFERENCE TO RELATED APPLICATIONS

The present invention claims priority to U.S. Provisional Patent Application Ser. No. 61/381,292, filed Sep. 9, 2010, which is incorporated by reference in its entirety.

### FIELD OF THE INVENTION

The present invention relates to systems and methods for displaying molecular probes and chromosomes, and chromosome information with which the probes are associated.

### BACKGROUND

Molecular probes are frequently used in research and diagnostic settings. Probes are often designed by the laboratories that intend to use them, but are manufactured at different locations by different entities. Over the years, a number of probe manufacturing specialists have emerged. To address the needs of their varied customer bases, these probe manufacturers have continued to provide more customer-friendly processes for ordering probes, including online ordering systems. However, problems and inefficiencies still exist in the communications and information sharing between probe manufacturers and suppliers and the researchers and diagnosticians that need and use the probes. What is needed are improved systems for designing, selecting, ordering, manufacturing, delivering, and otherwise managing information associated with molecular probes.

### SUMMARY OF THE INVENTION

Provided herein are techniques, methods, and/or systems useful for analyzing data typically related to biologic samples and most typically implemented on some type of logic execution system or module. Various aspects of the present invention may be incorporated into software.

In specific embodiments, the invention is directed to research and/or clinical applications where it is desired to design, select, order, manufacture, deliver, and/or otherwise manage information associated with molecular probes. The invention according to some embodiments is further directed to applications where it is desired to associate molecule probes with particular chromosomes or chromosomal regions and to display the relationship between the chromosome and the molecular probe(s) to a user.

For example, in some embodiments, provided herein are systems and methods for displaying molecular probe information using a computer system, comprising: in response to a search query from a user into the computer system: a) selecting corresponding chromosome information from a first database, wherein the corresponding chromosome information comprises chromosome data that can be used by the computer system to generate a chromosome image of at least a portion of a particular chromosome by compiling chromosome bands or chromosome fragments, wherein the chromosome image has a band-resolution of at least 125; b) selecting molecular probe information from a second database, wherein the molecular probe information comprises computer readable instructions for displaying molecular probe product information for one or more molecular probe products; and c) displaying the molecular probe product information and the chromosome image on the display screen, wherein the molecular probe product information is displayed in a manner such that the location on the chromosome image where the one or more molecular probe products would hybridize is indicated for at least one of the one or more molecular probe products.

In certain embodiments, the one or more molecular probe products comprise an in situ hybridization probe, a sequencing probe, an HLA-specific probe, a PCR primer, a PCR probe, a gene-specific probe, a micro-RNA probe, a bead-array probe, or a micro-array probe. In further embodiments, the one or more molecular probe products comprises a FISH probe or CISH probe. In additional embodiments, the chromosome image has a band-resolution of between 250 and 2000 or between 250 and 1000 (e.g., 275 . . . 350 . . . 550 . . . 690 . . . 800 . . . 1000 . . . 1500 . . . 2000). In further embodiments, the location on the chromosome image where the one or more molecular probe products would hybridize is indicated by 1) shading and/or coloring on the chromosome image, and/or 2) by at least one line from the molecular probe product information to the location on the chromosome image. In other embodiments, the display screen resides on a device of a customer and the first database and the second database resides on device of a molecular probe seller. In other embodiments, the selecting and the displaying is conducted by software housed on the device of the molecular probe seller.

In some embodiments, the search query from the user comprises a nucleic acid sequence input by the user. For example, the user may seek to identify regions of a chromosome, and associated molecular probes, that correspond to a sequence of interest. In some embodiments, the search query comprises information pertaining to a chromosome number, locus, regions, gene sequence, or other genetic location identification information. In some embodiments, the search query comprises information pertaining to a particular molecular probe (e.g., catalogue number, sequence, name, etc.).

One or more devices (e.g., desktop computer, laptop computer, hand held computing devices, phone, personal digital assistant, mainframe computer, etc.) may be used to implement the method. For example, a device may comprise a processor running software that carries out any one or more of the method steps and/or houses any one or more of the databases and/or provides the display screen. In some embodiments, the first database is stored on a first device, the second database is stored on a second device, a third device managed by a probe manufacturer/seller houses a processor that carries out the methods steps, and a fourth device managed by a user/customer contains the display screen. The displayed images may be transmitted (e.g., via Internet or any other means) from the third device to the fourth device. Likewise, the user interface may be transmitted from the third device to the fourth device. In some embodiments, the fourth device may download software that provides the user interface.

The systems and methods may be used with any desired molecular probes. In some embodiments, the probes are in situ hybridization probes (e.g., fluorescent in situ hybridization (FISH) probes). In some embodiments, the probes comprise a label, such as a fluorescent label or other chemical or physical moiety (e.g., quencher, binding partner, bead, etc.). In some embodiments, information pertaining to the molecular probe or its label are displayed on the display screen. Any desired information may be displayed, including, but not limited to probe sequence, location of the probe on the chromosome, label type, and the like. The probe information may be displayed in any desired manner. For example, in some embodiments, an information box is present on the user interface containing the information, which may be always present or may be activated by any desired mechanism (e.g., “mouse-over”). In other embodiments, a link is provided on the display, that when activated, displays the molecular probe information on the user interface or some other location.

In some embodiments, the displayed chromosome image comprises an entire chromosome or a portion thereof. In some embodiments, the chromosome image, regardless of scale selected or displayed, is accurate under the 550 band resolution standard (this enumeration describes the level of resolution of chromosome banding—i.e., the band can be detected at a resolution of 550 band per haploid set).

In some embodiments, the molecular probe's hybridization location is presented by providing coloring or shading on the chromosome image, the boundaries of the coloring or shading representing the 3' and 5' ends of the molecular probe, if hybridized to the highlighted region of the chromosome. Any other manner of overlaying the molecular probe hybridization location on the chromosome image may be used. In some embodiments, the color used to show the location of the molecular probe on the chromosome corresponds to a label on the molecular probe (e.g., red corresponds with a fluorophore label that provides a detectable signal in the red portion of the spectrum).

In some embodiments, chromosome information is further displayed on the display screen (e.g., on the user interface). Such information includes, but is not limited to, organism, chromosome number, locus, telomere, deletion, and polymorphism.

In some embodiments, commercial information pertaining to the molecular probe is displayed or displayable on the display screen. Such information can include, but it not limited to ordering information (e.g., catalogue number, price, volume, availability, etc.), regulatory information (e.g., FDA status, approved for in vitro diagnostic use, research use only, laboratory use, non-clinical use only, proficiency testing only, analyte specific reagent, unregulated, and CE mark status), and assay-specific information (e.g., assay type, medical indications, tissue specificity, and disease state).

In some embodiments, the displayed chromosome and/or the displayed molecule probe are dynamically rendered as vector graphics (e.g., using JavaScript). In some embodiments, the images are instantly rendered based upon a user request via the user interface. In some embodiments, the images are rendered without using flash technology, permitting more flexibility with regard to the range of devices that can be used to display and/or search the information and images.

Various embodiments of the invention can be embodied as a computer system and/or program. This system can optionally be integrated with other components for capturing and/or preparing and/or displaying data. Various embodiments of the present invention provide methods and/or systems for data analysis and display that can be implemented on a general purpose or special purpose information handling system using a suitable programming language such as Java, C++, Cobol, C, Pascal, Fortran, PL1, LISP, assembly, etc., and any suitable data or formatting specifications, such as HTML, XML, dHTML, SQL, TIFF, JPEG, tab-delimited text, binary, etc. In the interest of clarity, not all features of an actual implementation are described in this specification. It will be understood that in the development of any such actual implementation (as in any software development project), numerous implementation-specific decisions must be made to achieve the developers' specific goals and subgoals, such as compliance with system-related and/or business-related constraints, which will vary from one implementation to another.

The invention and various specific aspects and embodiments will be better understood with reference to the following drawings and detailed descriptions. For purposes of clarity, this discussion refers to systems, devices, methods, and concepts in terms of specific examples. However, the invention and aspects thereof may have applications to a variety of types of devices and systems.

Furthermore, it is well known in the art that logic systems and methods such as described herein can include a variety of different components and different functions in a modular fashion. Different embodiments of the invention can include different mixtures of elements and functions and may group various functions as parts of various elements. For purposes of clarity, the invention is described in terms of systems that include many different innovative components and innovative combinations of innovative components and known components. No inference should be taken to limit the invention to combinations containing all of the innovative components listed in any illustrative embodiment in this specification.

In certain embodiments, the present invention provides methods for displaying molecular probe product information using a computer system, comprising: in response to a search query from a user into said computer system: a) selecting corresponding viral genome information from a first database, wherein the corresponding viral genome information comprises genome data that can be used by the computer system to generate a viral genome image of at least a portion of a particular viral genome by compiling viral genome fragments; b) selecting molecular probe information from a second database, wherein the molecular probe information comprises computer readable instructions for displaying molecular probe product information for one or more molecular probe products; and c) displaying the molecular probe product information and the viral genome image on said display screen, wherein the molecular probe product information is displayed in a manner such that the location on the viral genome image where the one or more molecular probe products would hybridize is indicated for at least one of the one or more molecular probe products. In some embodiments, the viral genome is from a virus selected from the group consisting of: AAV—Adeno-Associated Virus Parvovirus; Adenovirus; Arena virus (Lassa virus); Astrovirus; BDG—Bacille Calmette-Guerin; Bunyavirus; Herpes virus; Calicivirus; Reovirus; Corona virus; Coxsackie virus; Cytomegalovirus; Flavivirus; Ebola virus, Epstein-Barr Virus; Echovirus; Togaviruses; Hantavirus; Hepatitis A virus, Hepatitis B virus; Hepatitis C; Herpes virus, Herpes Varicella-Zoster virus; HIV Human Immunodeficiency Virus; HPV—Human Papilloma Virus; HSV 1 Herpes Simplex I; HSV 2 Herpes Simplex II; HTLV; Influenza virus A, B, C; Lassa Virus; Arenavirus; Rubella; Paramyxovirus; Norovirus; Parvo virus, Poxvirus; Reovirus Rhinovirus; West Nile Virus; and Yellow fever virus.

### DESCRIPTION OF THE FIGURES

FIG. 1 shows an exemplary product landing page.

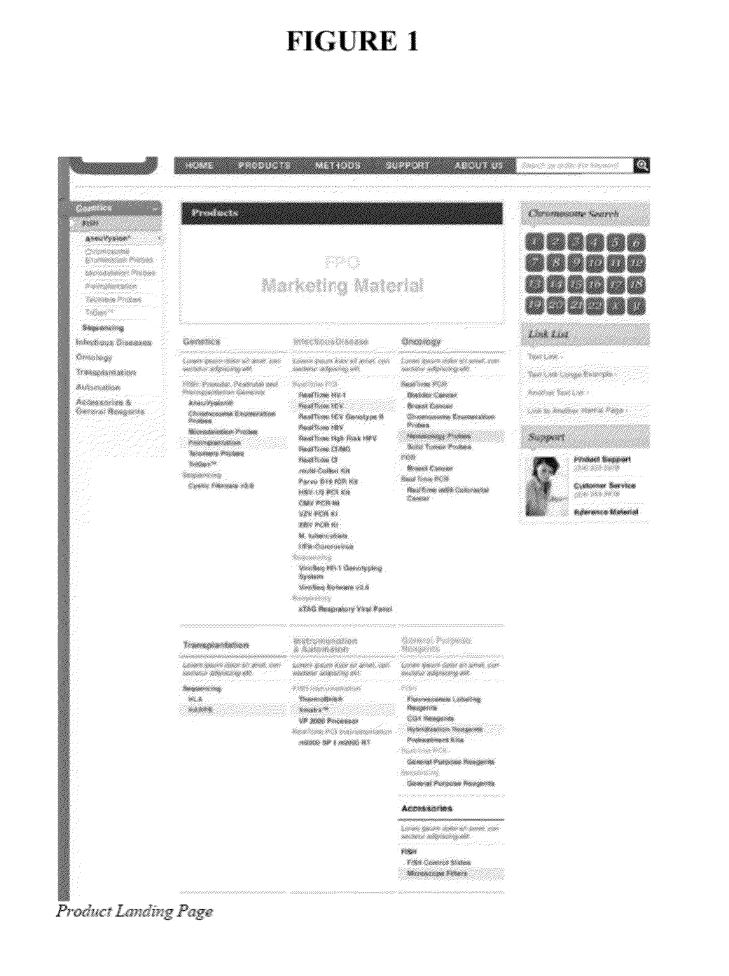

FIG. 2 shows an example of a chromosome search page layout.

FIG. 3A shows a landing page for chromosome 4, where a picture of chromosome 4 is on the left and offered chromosome 4 products are on the right. FIG. 3B shows that when a user places the cursor on a particular FISH probe, the chromosomal hybridization location(s) of FISH probe(s) is automatically shown on the picture of the chromosome.

FIG. 4 shows that when a user clicks on a particular FISH probe product, not only is the chromosomal location of the probe(s) on the chromosome shown, but also a drop down box for the product is shown that contains additional details about the product.

FIG. 5 shows that when a user clicks on a particular FISH probe product, not only is the chromosomal location of the probe(s) on the chromosome shown, but also a drop down box for the product is shown that contains additional details about the product, such as the different fluorphores that can be used to label the probes.

FIG. 6A shows a chromosome selection landing page, where the production information box shows three different probes included in a probe mixture, each probe with a separate fluorophore. FIG. 6B shows a probe mixture that includes multiple probes in different locations on the same chromosome, which is shown by lines to the pictured chromosome. FIG. 6C shows 2 probe mixtures for 1 product contain multiple probes that are on different chromosomes.

FIG. 7A shows a landing page for chromosome 18, where a picture of chromosome 18 is on the left and offered chromosome 18 products are on the right. FIG. 7B shows that when a user places the cursor on a particular FISH probe, the chromosomal hybridization location of the FISH probe is automatically shown on the picture of the chromosome. FIG. 7C shows that when a user clicks on a particular FISH probe product, not only is the chromosomal location of the probe on the chromosome shown, but also a drop down box for the product is shown that contains additional details about the product.

FIGS. 8A and 8B show a chromosome selection landing page which shows that product information can contain information such as the multiple probes used in a particular kit (e.g., IVD kit) as well as the labels used by the various probes.

### DEFINITIONS

As used herein, a “database,” refers to a collection of data points in digital form, regardless of organization. One example of a database is an XML file (Extensible Markup Language), which refers to a set of rules for encoding documents in machine-readable form.

As used herein, “molecular probe information” refers to digital information regarding a nucleic acid sequence that can hybridize to a larger sequence such as a portion of a chromosome or a portion of a viral genome, and specifically includes both probes and primers.

### DESCRIPTION OF THE INVENTION

The present invention provides systems and methods for displaying molecular probes and chromosomes, and chromosome information with which the probes are associated.

In some embodiments, chromosome searches are integrated with probe data and information, including ordering information. In some embodiments chromosomes or portions thereof are drawn in a dynamic manner with accurate rendering in a fast and otherwise user friendly manner. The displayed information may be compatible with any desired display device or format including but not limited to computer monitors.

In certain embodiments, such graphic chromosome location displays will be used in conjunction with an internet web site (e.g., on a computer) in order to facilitate product search. Such graphic displays can also be displayed on the user interface of other devices, such as smartphones (e.g., IPHONE), IPAD, and Android applications to facilitate easy access to the product catalog from mobile users. In particular embodiments, the systems and methods of the present invention have immediate probe map and hybridization images that pop up from links directly on the chromosome search, and the chromosomes themselves are scalable and accurate to, for example, the 550 band resolution standard. In some embodiments, the searchable graphic user interface (“sGUI”) has advantages to the website user in that it has very fast page load times, accurate chromosome representation, and probe detail that overlays in the correct color and location, as well as being integrated with a product catalog on a web site.

In certain embodiments, the sGUI provides advantages to a business such as: 1) direct control of the data for the chromosome search from the Pepper™ content management system; 2) chromosome search information is subject to the same regulatory rules as the standard ad/promo material on the website; and 3) efficient to update to a higher resolution such as 700- or 800-band, by directly updating the XML, file within the system.

In particular embodiments, the sGUI allows users to browse the 24 human chromosomes and see each of the fluorescent in situ hybridization (FISH) probes which are manufactured and sold by a particular vendor. In some embodiments, the chromosome search web application retrieves data from two sources: product data which is maintained by the business and stored in a content management system (e.g., the Pepper™ content management system), and an XML representation of the 550 band (or other band) resolution of a human chromosome. The chromosome and probe representations may be dynamically rendered as vector graphics using JavaScript (e.g., the Dojo Library1) and instantly rendered based upon user request. The result is a visual representation of a given human chromosome with corresponding loci and fluorophore colors for the FISH Probe Product Catalog.

### EXEMPLARY EMBODIMENT

Provided below is an exemplary embodiment of how a sGUI of the present invention may be laid out.

C-Frame

The C-frame will allow site users to easily navigate to different areas of the site. It is composed of 3 separate areas —the header, left-navigation, and the footer.

Utility Navigation

The utility navigation is a simple set of links to direct the site user to their Shopping Cart, the Product Catalog form, or to the company's homepage. The location drop-down will allow the site user to switch between US and OUS versions of the site. On change of the location, a modal window will appear so that the site user can agree to the regional disclaimer. If accepted, the site user will be redirected to the homepage of the other version of the site. The shopping cart link will direct the user to login to the ecommerce system. A print feature is also available from the Utility Navigation. This will provide a print-friendly version of the current page. ‘ShareThis’ is a customizable widget that will allow site users to email a page to a friend, or share the page to other social media services.

Main Horizontal Navigation

The main navigation will allow a site user to quickly navigate to the primary landing pages of the site. When hovering over a main navigation element, the style of the navigation element will change and the fly-out navigation will appear. The fly-out will allow the site user to navigate directly to a second level-landing page. On mouse out, the fly-out navigation will disappear and the style of the navigation element will return to its default state. These will drive the content of the horizontal fly-out navigation. Exemplary navigation buttons on the sGUI include the following: Home (no sub nav elements); Products (Genetics, Infectious Disease, Oncology, Transplantation (OUS only), Analyte Specific Reagents (US only), Automation, General Purpose Reagents, Accessories); Technologies (e.g., RealTime PCR, FISH, Sequencing, Bead Array, Bio-Identification); Support (e.g., Contact Us, Request Information, Technical Library (OUS), FISH Tech Support, Laboratories, What's New); and About Us (e.g., Partnerships & Collaborations, Conferences & Events, Careers, Press Releases, Newsletters).

Left Navigation

In this exemplary embodiment, the left navigation will not appear on the homepage or Chromosome Search. On every other page, the navigation will be selected based on the site users current location on the site. The top level of the left navigation will be equal to the data in the fly-out navigation. For example, the Products section will have product-specific navigation elements only (Genetics, Infectious Disease, Oncology, Transplantation, Automation, Accessories & Reagents). Controlling the items living within the navigation is a manual process of updating the Pepper Sitemap. CMS users will add items to the sitemap in the proper location so that the navigation is built correctly. This allows the navigation to be flexible, driven separately from the site folder structure, which assigns permissions.

Footer

The footer will reproduce the links in the primary and secondary navigation. It will also contain the company copyright and intended use information, in addition to links to the Legal Documents (Privacy Policy and Terms of Use).

Permissions

In this exemplary embodiments, none of the sections within the c-frame will be directly editable by a CMS user. However, with the appropriate permissions, a CMS user will be able to edit the sitemap to change the navigation tree (aka sitemap), which will be reflected in the top and left navigation as well as the footer.

Homepage

The main rotating banner may, for example, feature up to 5 different marketing banners, which can include both image and text. The background of the image should have the ability to be clickable, as well as adding buttons within the image. The default display time is 5 seconds per slide. After 5 seconds, the previous image and text will fade out while the next image and text fades in. The number selector will change based on what image is being viewed. The pause button will stop transitions between slides, and once clicked, will change to a play button. On click of the play button, the slides will resume and the button will change back to a pause button.

Product Categories

The product categories section will direct the site users to the different product category landing pages. The content author will enter the data in this list. On click of the product categories header, the site user will be directed to the product category-landing page. On click of a specific product category, the site user will be directed to the specific product category-landing page (i.e. Automation Landing page).

Technologies

The technologies section with direct the site user to explore different technologies that are offered on the website. The content author will enter the data in this list. On click of the Technologies header, the site user will be directed to the technologies landing page. On click of a specific technology, the site user will be directed to the specific technology-landing page (i.e. FISH landing page).

Fish Chromosome Search

This section is a non-editable region that will direct the site user to a specific chromosome within the Chromosome search feature (see “Chromosome Search”). On click of the FISH Chromosome Search header, the site user will be directed to the Chromosome search-landing page.

Spotlight

The spotlight section serves as another area where marketing and other material can be highlighted on the homepage. The contents of this section will be decided by content authors, and links can be to anywhere on the site.

Worldwide Contact

The worldwide contact map will allow a site user to click on a continent and be directed to the proper contact information on the worldwide contact information page. When hovering over a continent, the continent will highlight, giving a visual cue to the site user for which area they are clicking through.

Support

The support section is CMS user-editable and will contain pertinent technical and customer service information at a glance. Clicking on the Support title will take the site user to the support-landing page.

Latest News, Events, & Collaboration

The body of this section is CMS user editable. A pre-chosen image can be selected and inserted, and the text will be free form.

Additional Information

The additional information section will be a dropdown that allows a site user to quickly access forms within the site, and make contact with the host company. The drop down will be populated differently depending upon the homepage (US/OUS).

Flexible Landing Pages

Flexible landing pages are pages of either a three-column or four-column layout that allow free entry of marketing content, links and copy.

Queried Landing Pages

Queried landing pages are pages with three column layout that have an editable region for marketing material at the top of the page, but are driven by a product query at the bottom of the page that can appear either as tabbed or as listed product detail page links. The functionality is provided so that AMD Business does not have to manage lists of more than 10-15 products.

Landing Page Distribution

The following table details the distribution of types of landing pages that will be present at launch. These can be cross-referenced with the sitemap to see their location within the tree.

TABLE 1

| | Flexible | | Queried | |
|---|---|---|---|---|
| | | | | 3 column |
| | 3 column | 4 column | 3 column (list) | (tabbed) |
| US | Support | Technologies | LSI | |
| | About Us | Product Cat. | Micro- | |
| | Microscope | Support | deletion | |
| | Filters | Landing | | |
| OUS | Support | Technologies | Micro- | Hematology |
| | About Us | Product Cat. | deletion | Solid Tumor |
| | Breast Cancer | Support | | |
| | Microscope | Landing | | |
| | Filters | | | |

In addition to the flexible and queried landing pages, there will be a Product landing page, and a chromosome landing page. The Queried Pages will be populated with links to Product Detail pages, and will be driven from the metadata on all product detail pages as follows:

Hematology (GUS)

All products in this query will have Oncology as the Product Category, Hematology as the Product Grouping, and OUS as the Site.

Solid Tumor (GUS)

All products in this query will have Oncology as the Product Category, Solid Tumor as the Product Grouping, and OUS as the Site.

Microdeletion (GUS)

All products in this query will have Genetics as the Product Category, Microdeletion as the Probe Type, and OUS as the Site.

Microdeletion (US-ASR)

All products in this query will have Genetics as the Product Category, Microdeletion as the Probe Type, Analyte Specific Reagent as the FDA Status, and US as the Site.

LSI (US-ASR)

All products in this query will have Locus Specific Identifier as the Probe Type, Analyte Specific Reagent as the FDA Status, and US as the Site.

Product Detail Pages

Products for US and OUS will be separate pieces of content within the content management system (e.g., Pepper). This allows the business rules to easily be followed for both types of content, including medical, regulatory, and legal considerations. All product content will reside in three separate content templates. However, some of the functionality will be shared between the templates.

Fish Product Detail Template

The FISH product detail page will open with the 2nd tab, Probe Maps & Design, open by default. Tabs: Description (e.g., includes probe and product descriptions); Probe Maps & Design (e.g., includes probe maps, ideograms, results of hybridization); instrumentation (e.g., includes kit contents, probe mixtures (or vials)); Reference & Support (e.g., includes MSDS, Package Insert, Certificate of Analysis, other documentation, references); and Related Products. In general, all fish Fish product detail pages have the Chromosome Search as the upper right gutter callout.

All Other Product Detail Template

Tabs: Description; Design; Instrumentation; Reference & Support; and Related Products.

Non-Tabbed Product Detail Template

This type of page is for use on products that do not require tabular detailed information such as CEPs, ASRs or HLA/HARPS. The page will mostly be populated by content authors, and can contain: Probe information table (e.g., Name, Location, and Fluorophore); Ordering information; and CMS user content (e.g., Probe Map, Ideogram, and Results of Hybridization).

Product Detail Page Metadata

The metadata for the product detail pages will power many of the automated features in the site, including: Chromosome Search; Product category and sub-category landing pages; Product detail page; Ordering information; and Product Probe Description. Some fields will only be available for US or OUS only, based on the Site metadata selection. On initial page creation, and when clicking on the Page Properties the following fields are available: Site —US and/or OUS; Keywords (approved picklist drop-down and text field for free-form entry); and Description (text). Clicking the “Product Metadata” button in the Pepper Toolbar will allow a CMS user to enter product metadata. On click, a modal window will be displayed with the following fields:

Regulatory Information: FDA Status —US only (picklist) (e.g., FDA Approved, For In Vitro Diagnostic Use, For Research Use Only, For Laboratory Use, For Non-Clinical Use Only, For Proficiency Testing Only, Analyte Specific Reagent, and Unregulated); CE Status —OUS only (e.g., CE Approved, and Not Approved); FDA Approved —OUS Only.

Product Specific Information: Technology (e.g., FISH, Real-time PCR, PCR, Sequencing, Bead Array, BioIdentification, and No Technology); Product Category (e.g., Instruments & Automation, Infectious Disease, Oncology, Genetics, Transplantation (OUS only), General Purpose Reagents, Accessories, and Not associated to a product category); Product Grouping (e.g., Hematology, Solid Tumor, Breast Cancer, Bladder Cancer, Prenatal Postnatal, Preimplantation); Disease State (e.g., Acute Lymphoblastic Leukemia (ALL), Acute Myelogenous Leukemia (AML), Chronic Lymphocytic Leukemia (CLL), Chronic Myelogenous Leukemia (CML), Multiple Myeloma, Myelodysplastic Syndrome (MDS), Non-Hodgkins Lymphoma, Sex Mismatched Bone-Marrow Transplant Management (+BMT), Barrett's Esophagus, Gliomas, Lung Cancer, Other Cancers, Prostate Cancer, and Sarcomas); Probe type; Locus Specific Identifier; Chromosome Enumeration; Microdeletion; Telomere; Results of Hybridization Image; Normal (driven from image selector); Caption (text); Abnormal (driven from image selector) Caption (e.g., Name, Chromosome (1 through 22, X, and Y), Loci, Probe display name, Fluorophore (e.g., Orange, Gold, Yellow, Red, Aqua, Blue, and Green)); File path name to Probe Map (driven from image selector); Mix Information (can include multiple Probes); Mix number; Mix label; Product Name (can include multiple mixes or multiple probes); Ordering Information; Display Name; and Quantity.

The FDA and CE status selection will determine what information is displayed below the Indications and Limitations of Use. The verbiage is as follows: For In Vitro Diagnostic Use; Analyte Specific Reagent—Analytical and performance characteristics are not established; For proficiency testing only—Not for diagnostic use; For Research Use Only—Not for use in diagnostic procedures; For Laboratory Use; and CE Marked—Not available in United States.

Form Behavior

Required form information will be shown with a red asterisk at the beginning of the field description. The form labels should be above the form input. JavaScript validation should be performed after the site user has clicked or entered text in a box. Errors should be displayed by highlighting the form region red, and displaying a detailed error message describing the reason for the error. Form submission will not be allowed until all errors are cleared. In addition to backend validation, server-side validation will also be performed to eliminate the risk of JavaScript being turned off during a form submission. On server-side error, the form will be returned with the relevant error message displayed and highlighted.

Right Side Callouts & Modules

Modules can be created on a per-page basis, or inserted from pre-established, shared modules. The content owner of that particular page, including both landing pages and product detail pages, determines the modules that live on the pages. Some of the pre-defined modules are detailed in the “Types & Functionality” section.

Chromosome Search Callout

This module is not CMS user editable. On mouse hover of the buttons, the coloring will change. On click of a button, the site user will be redirected to specified chromosome within the Chromosome Search.

Chromosome Search

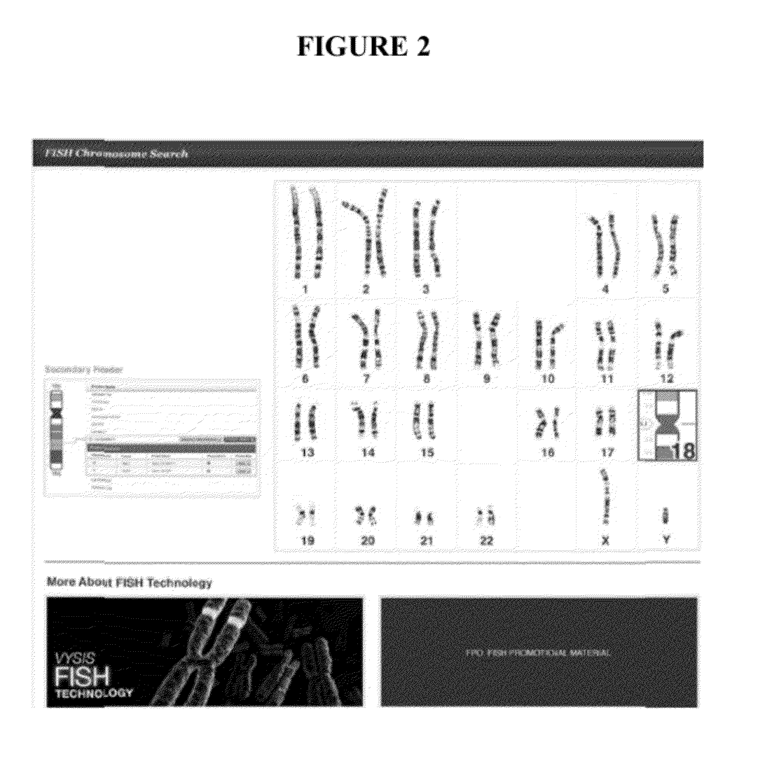

The purpose of the landing page for Chromosome Search will be to explain the feature to site users and guide them to the appropriate section. FIG. 2 shows an example of a chromosome search page layout.

The left-side marketing content will be user-editable, and should explain the purpose and usage for the Chromosome Search. The right side of the page will display the karyotypes for each chromosome. On hover of a karyotype, a sample of the ideogram for that chromosome will be displayed. The area below will be user-editable and can contain shared modules or new marketing material.

Chromosome Search

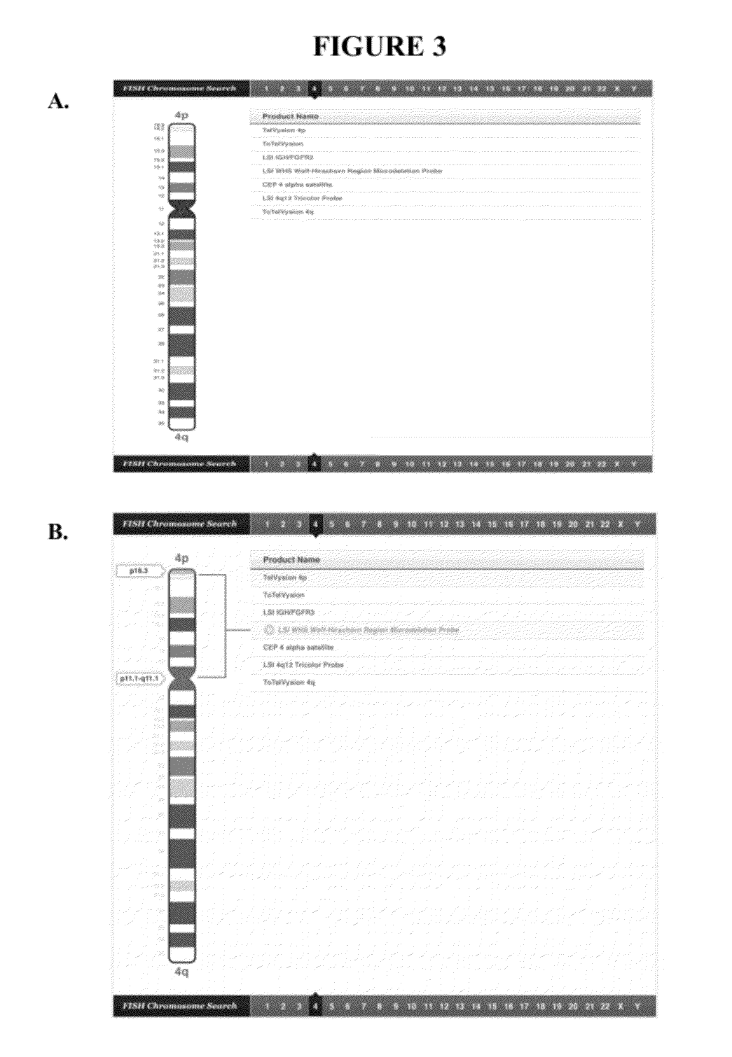

The Chromosome Search will now be created dynamically, based on data entered in the product detail metadata. Upon entering the Chromosome Search, the site user will be presented with a graphical chromosome and a listing of precuts that have usage on the current chromosome. Navigation between chromosomes will be done via horizontal navigation at the top or bottom of the Chromosome Search. The Chromosome image will be labeled at the top and bottom with the current chromosome number and the arms. For example, Chromosome #4 will be labeled at the top as 4p and at the bottom as 4q (see FIG. 3A, which shows the view after clicking on 4 in the chromosome navigation or callout).

On mouse hover of a product name, a highlighter on the product title will appear, in addition to a location line or set of lines that depict where in the chromosome the product is used. The highlight and location lines will disappear after hovering off the product name. The label on the left-hand side of the chromosome will be equal to the locus information in the product table. This is shown in FIG. 3B, which shows the hover state for chromosome 4.

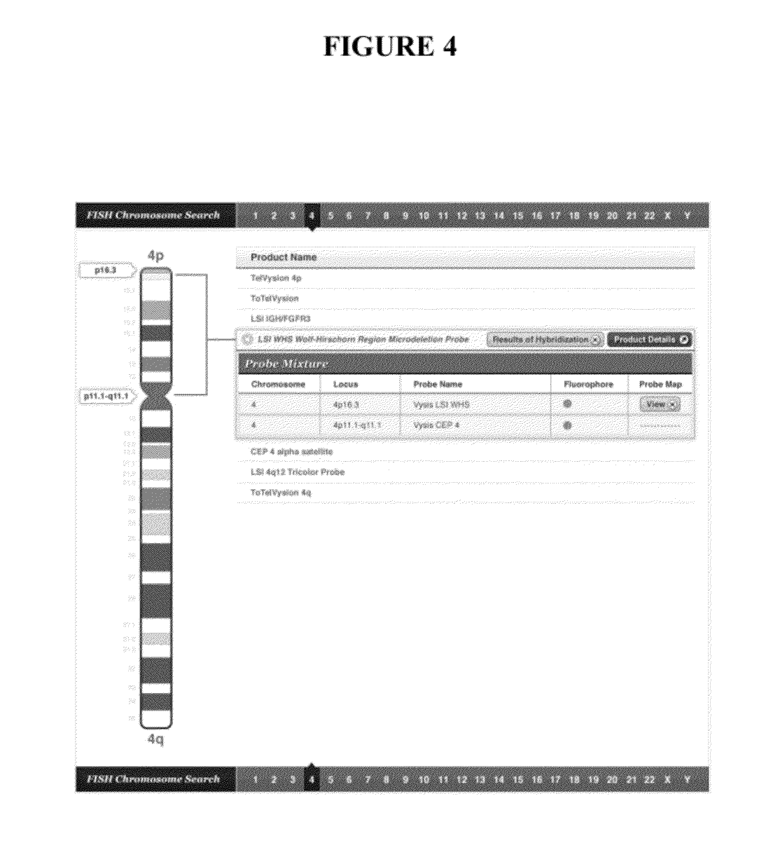

On click of a product name, a table will extend below the product name. In the header of the table, the site user may hide the table by clicking the “X” button. They may also navigate directly to the product detail page by clicking the “Product Detail” button. Clicking on another product name will hide the previous product information and display the new product information. Once product information has been expanded, the hover behavior of the other products will change. The name of the product will still change its highlight state, but the lines to the chromosome will not appear. This is shown in FIG. 4, where a product name was clicked, which then shows probe detail including lines to relevant location on chromosome

Clicking the Results of Hybridization button will display a modal window with the image of the results of hybridization displayed. 1 or 2 images may be displayed for results of hybridization (normal or abnormal). Captions for the images will be available in this view. In the body of the table, each probe will be listed. If a probe is included in a mix or vial, it will be used to organize the order of the probes. The chromosome, locus, name, fluorophore, and ideogram for each probe will be listed. Clicking “View” for the ideogram will open a modal window and display the ideogram of the chromosome listed on the same line as the probe. The product name will be displayed based on product page metadata. If the product contains single probe ordering information, the display name in the Chromosome search should iterate over the list of single probe ordering lines and use the Display Name attribute for the title of the product. If the product contains product ordering information, the Chromosome search should iterate over the product ordering lines and use the title of the product as the product name and display. In general, there should not be a case where a product has both single probe ordering lines and product ordering lines together.

Multiple Fluorophores

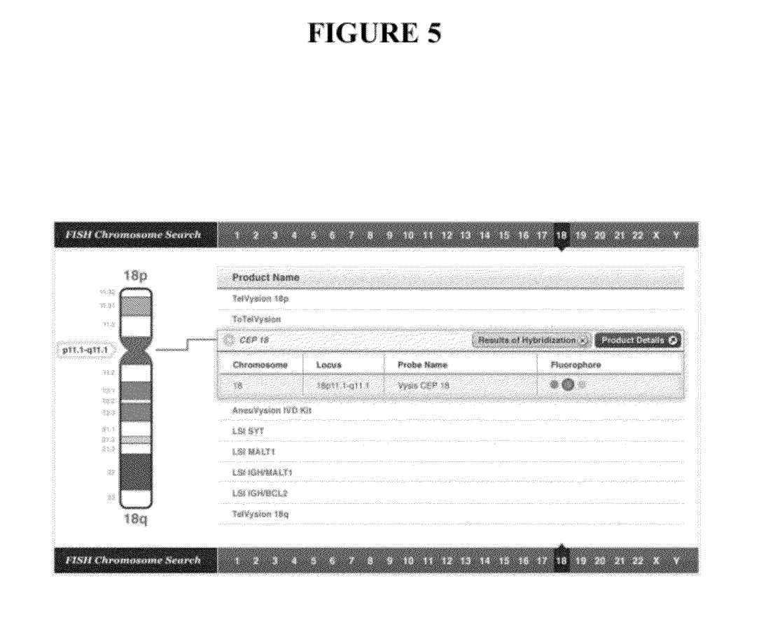

Fluorophores can occur in multiple ways for a probe or group of probes. In this case, as shown in FIG. 5, one probe has 3 fluorophore options at one specific location. The default highlight state will be the first fluorophore in the list. The highlight state of the probe background and the chromosome will change on hover of the other fluorophore options.

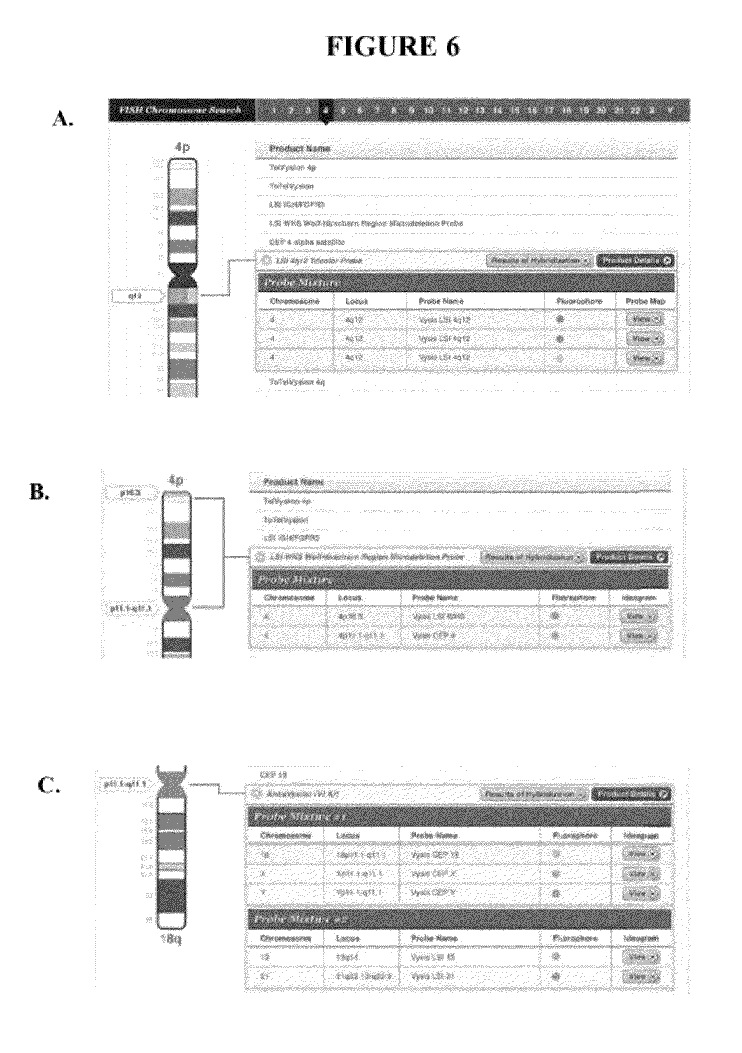

In this case, as shown in FIG. 6A, there are 3 different probes included in the Probe Mixture. Each probe has a separate fluorophore.

In this case, as shown in FIG. 6B, a probe mixture includes multiple probes in different location on the same chromosome.

In this case, as shown in FIG. 6C, 2 probe mixtures for 1 product contain multiple probes that are on different chromosomes.

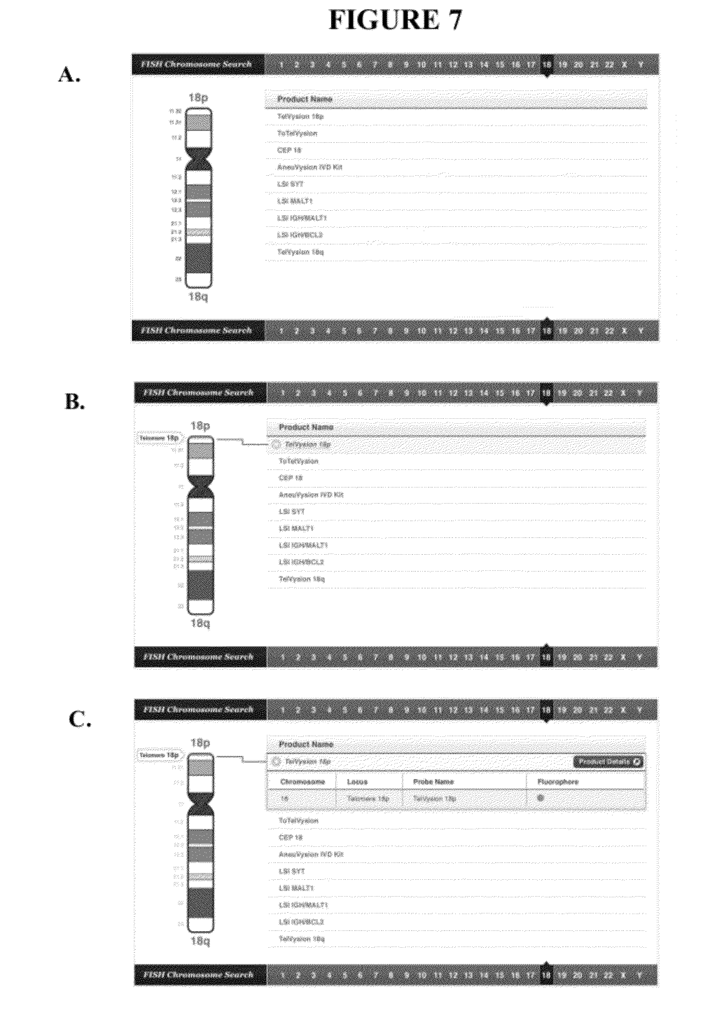

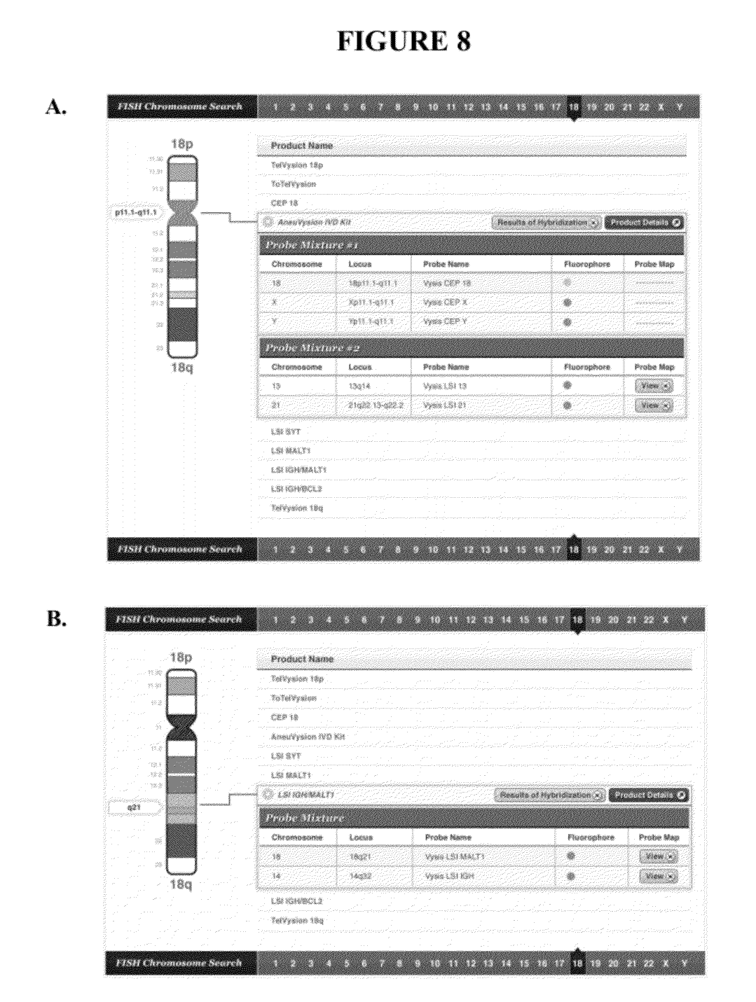

FIG. 7A shows a landing page for chromosome 18, where a picture of chromosome 18 is on the left and offered chromosome 18 products are on the right. FIG. 7B shows that when a user places the cursor on a particular FISH probe, the chromosomal hybridization location of the FISH probe is automatically shown on the picture of the chromosome. FIG. 7C shows that when a user clicks on a particular FISH probe product, not only is the chromosomal location of the probe on the chromosome shown, but also a drop down box for the product is shown that contains additional details about the product. FIGS. 8A and 8B further show that product information can contain information such as the multiple probes used in a particular kit (e.g., IVD kit) as well as the labels used by the various probes.

We claim:

1. A method for displaying molecular probe product information using a computer system, comprising: in response to a search query from a user into said computer system:
a) selecting corresponding chromosome information from a first database, wherein said corresponding chromosome information comprises chromosome data that can be used by said computer system to generate a chromosome image of at least a portion of a particular chromosome by compiling chromosome bands or chromosome fragments, wherein said chromosome image has a band-resolution of at least 125;
b) selecting molecular probe information from a second database, wherein said molecular probe information comprises computer readable instructions for displaying molecular probe product information for one or more molecular probe products; and
c) displaying said molecular probe product information and said chromosome image on said display screen, wherein said molecular probe product information is displayed in a manner such that the location on said chromosome image where said one or more molecular probe products would hybridize is indicated for at least one of said one or more molecular probe products.

2. The method of claim 1, wherein one or more of said first database, said second database, and said display screen reside on separate computing devices.

3. The method of claim 2, wherein said separate computing devices are in communication with one another by a communication network.

4. The method of claim 1, wherein said one or more molecular probe products comprise an in situ hybridization probe, a sequencing probe, an HLA-specific probe, a PCR primer, a PCR probe, a gene-specific probe, a micro-RNA probe, a bead-array probe, or a micro-array probe.

5. The method of claim 1, wherein said one or more molecular probe products comprises a FISH probe.

6. The method of claim 1, wherein said one or more molecular probe products comprises a label.

7. The method of claim 1, wherein said search query from said user comprises a nucleic acid sequence input by said user.

8. The method of claim 1, wherein said search query from said user comprises a chromosome or chromosome location input by said user.

9. The method of claim 1, wherein said search query from said user comprises a probe identity input by said user.

10. The method of claim 1, wherein said chromosome image comprises an entire chromosome.

11. The method of claim 1, where said chromosome image comprises no more than a portion of a chromosome.

12. The method of claim 1, wherein said chromosome image has a band-resolution of between 250 and 1000.

13. The method of claim 1, wherein said location on said chromosome image where said one or more molecular probe products would hybridize is indicated by 1) shading and/or coloring on said chromosome image, and/or 2) by at least one line from said molecular probe product information to said location on said chromosome image.

14. The method of claim 1, wherein said display screen resides on a device of a customer and said first database and said second database resides on device of a molecular probe seller.

15. The method of claim 1, wherein said displayed molecular probe product information is displayed in a color that corresponds to a label on said probe.

16. The method of claim 1, wherein said molecular probe product information comprises at least one nucleic acid sequence.

17. The method of claim 1, wherein said molecular probe product information comprises ordering information.

18. The method of claim 1, wherein said molecular probe information comprises regulatory information.

19. The method of claim 1, wherein said molecular probe product information comprises assay-specific information.

20. The method of claim 19, wherein said assay specific information comprises:
assay type, medical indications, tissue specificity, and disease state.

21. The method of claim 1, wherein said corresponding chromosome information further comprises information selected from the group consisting of: organism, chromosome number, locus, telomere, deletion, and polymorphism.

22. The method of claim 1, wherein said displayed chromosome image and said displayed molecule probe product information are dynamically rendered as vector graphics.

23. The method of claim 1, wherein said displayed chromosome image and said displayed molecule probe product information are nearly instantly rendered, or rendered in less than 1 second, based upon a user request via said user interface.

24. A method for displaying molecular probe product information using a computer system, comprising: in response to a search query from a user into said computer system:
a) selecting corresponding viral genome information from a first database, wherein said corresponding viral genome information comprises genome data that can be used by said computer system to generate a viral genome image of at least a portion of a particular viral genome by compiling viral genome fragments;
b) selecting molecular probe information from a second database, wherein said molecular probe information comprises computer readable instructions for displaying molecular probe product information for one or more molecular probe products; and
c) displaying said molecular probe product information and said viral genome image on said display screen, wherein said molecular probe product information is displayed in a manner such that the location on said viral genome image where said one or more molecular probe products would hybridize is indicated for at least one of said one or more molecular probe products.
